(19) United States
(12) Patent Application Publication
(10) Pub. No.: US 2010/0274410 A1
(43) Pub. Date: Oct. 28, 2010

(54) METHODS AND SYSTEMS FOR CUSTOMIZING CONTENT FOR AN OCCUPANT OF A VEHICLE

(75) Inventors: MATTHEW TSIEN, Bloomfield Hills, MI (US); FRED W. HUNTZICKER, Ann Arbor, MI (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/429,917

(22) Filed: Apr. 24, 2009

(51) Int. Cl. G06F 19/00

(52) U.S. Cl. 701/1

(57) ABSTRACT

A method for customizing content for an occupant of a vehicle during a vehicle drive includes the steps of determining a driving mode of the vehicle and determining appropriate content for the occupant based on the driving mode. The driving mode represents one or more characteristics of the vehicle drive.

### TECHNICAL FIELD

The present invention generally relates to the field of vehicles and, more specifically, to methods and systems for customizing content for an occupant of a vehicle.

### BACKGROUND OF THE INVENTION

Occupants of vehicles, such as drivers of automobiles or other types of vehicles, often prefer to have certain types of content, such as information or entertainment media, provided for them during a vehicle drive. The occupants' preferences for content, such as information or entertainment media, may vary based on different factors pertaining to the vehicle drive. For example, a driver may prefer to listen to one type of content while driving to work, another type of content while driving home from work, still another type of content while driving on the weekend, and yet another type of content while driving on vacation, among various other examples.

Accordingly, it is desirable to provide an improved method for customizing content, such as information or entertainment media, for an occupant, such as a driver of the vehicle, for example that pertains to the occupant's preferences pertaining to the vehicle drive. It is also desirable to provide an improved program product for such customizing of content for an occupant of a vehicle. It is further desirable to provide an improved system for such customizing of content for an occupant of a vehicle. Furthermore, other desirable features and characteristics of the present invention will be apparent from the subsequent detailed description and the appended claims, taken in conjunction with the accompanying drawings and the foregoing technical field and background.

### SUMMARY OF THE INVENTION

In accordance with an exemplary embodiment of the present invention, a method for customizing content for an occupant of a vehicle during a vehicle drive is provided. The method comprises the steps of determining a driving mode of the vehicle and determining appropriate content for the occupant based on the driving mode. The driving mode represents one or more characteristics of the vehicle drive,

In accordance with another exemplary embodiment of the present invention, a program product for customizing content for an occupant of a vehicle during a vehicle drive is provided. The program product comprises a program and a computer-readable signal-bearing medium. The program is configured to at least facilitate determining a driving mode of the vehicle and determining appropriate content for the occupant based on the driving mode. The driving mode represents one or more characteristics of the vehicle drive. The computer-readable signal-bearing medium bears the program.

In accordance with a further exemplary embodiment of the present invention, a system for customizing content for an occupant of a vehicle during a vehicle drive is provided. The system comprises a vehicle interface and a server. The vehicle interface is configured to at least facilitate providing information pertaining to one or more characteristics of the drive. The server is configured to at least facilitate determining a driving mode of the vehicle based on the one or more characteristics of the vehicle driver, and determining appropriate content for the occupant based on the driving mode.

### BRIEF DESCRIPTION OF THE DRAWINGS

The present invention will hereinafter be described in conjunction with the following drawing figures, wherein like numerals denote like elements, and wherein:

FIG. 1 is a functional block diagram of a system for customizing content for an occupant of a vehicle during a vehicle drive, in accordance with an exemplary embodiment of the present invention; and

FIG. 2 is a flowchart of a process for customizing content for an occupant of a vehicle during a vehicle drive, and that can be implemented in connection with the system of FIG. 1, in accordance with an exemplary embodiment of the present invention.

### DETAILED DESCRIPTION OF THE INVENTION

The following detailed description is merely exemplary in nature, and is not intended to limit the invention or the application and uses of the invention. Furthermore, there is no intention to be bound by any expressed or implied theory presented in the preceding technical field, background, brief summary or the following detailed description.

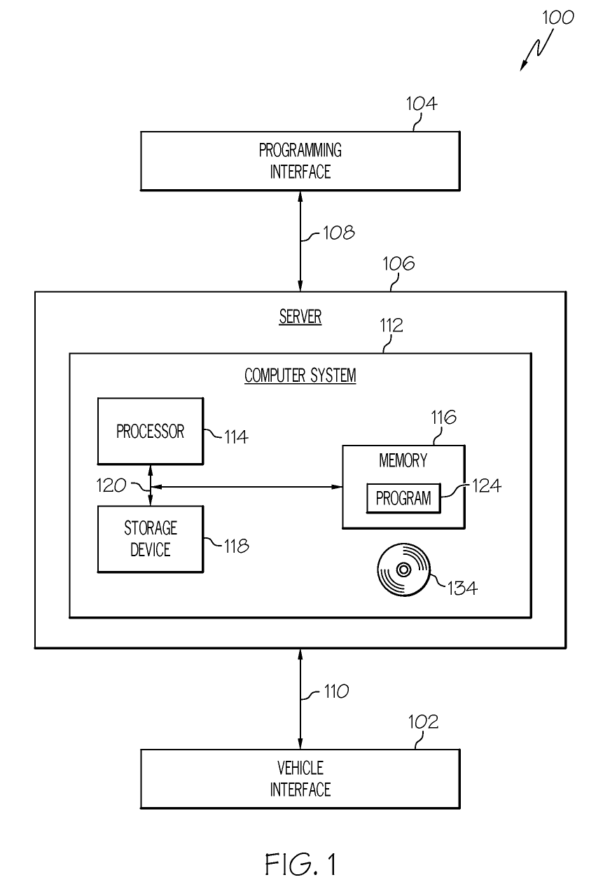

FIG. 1 is a functional block diagram of a system 100 for customizing content for an occupant of a vehicle during a vehicle drive, in accordance with an exemplary embodiment of the present invention. As depicted in FIG. 1, the system includes a vehicle interface 102, a programming interface 104, a server 106, a back-end connection 108, and a vehicle connection 110.

The vehicle interface 102, the programming interface 104, and the server 106 may be physically partitioned in any number of different manners. For example, in one exemplary embodiment, the vehicle interface 102, the programming interface 104, and the server 106 are each disposed within the vehicle. In another exemplary embodiment, the programming interface 104 may be on the server 106. In yet another exemplary embodiment, the programming interface 104 and/or the server 106 may be remote from the vehicle. Various other portioning structures or formats may also be implemented in other embodiments of the present invention, along with various other possible variations to the system 100 of FIG. 1 and/or the components thereof.

As referenced herein, the term content corresponds to any of numerous different types of content that a vehicle driver or other occupant may listen to or otherwise experience during a vehicle drive, such as, by way of example only, podcasts; financial updates, broadcasts, or related information or content; sports updates, broadcasts, or related information or content; news updates, broadcasts, or related information or content; weather updates, broadcasts, or related information or content; travel updates, broadcasts, or related information or content; traffic updates, broadcasts, or related information or content; political updates, broadcasts, or related information or content; talk shows or related information or content; educational broadcasts, or related information or content; audiobooks or related information or content; music and/or related information or content, and/or specific types of music, genres of music and/or musicians and/or related information or content; specific media personalities or related information or content; and/or other information and/or entertainment selections, among other possible types of content.

The vehicle interface 102, in accordance with a preferred embodiment, is configured to obtain, and provide to the server 106, information pertaining to one or more characteristics of a vehicle drive for use by the server 106 in determining a particular driving mode for the vehicle drive. By way of example only, such characteristics may include a time of day, a day of the week, a month of the year, a day of the month, and/or various measures of geographic position, location, or movement of the vehicle, among various other types of information pertaining to the vehicle drive. Also in a preferred embodiment, the drive-related inputs and information are obtained by the vehicle interface 102 from one or more non-depicted sensors, clocks, global positioning service (GPS) devices and/or other devices on the vehicle and/or coupled thereto. Also by way of example only, exemplary driving modes may include the following driving modes, among others: driving to work, driving to work on time, driving to work early, driving to work late, driving home from work, driving home from work early, driving home from work late, weekend driving, vacation driving, morning driving, midday driving, evening driving, city driving, country driving, freeway driving, driving to a specific destination (for example, a skiing destination or a beach destination), and/or any one or more of a number of different possible types of driving modes.

In addition, in certain embodiments, a drive mode learning algorithm may also be implemented. In certain embodiments, the drive mode learning algorithm would suggest likely modes for inclusion in the pre-programming of the driver or occupant content preferences and/or for receiving confirmation from the driver that a particular type of driving mode is in fact occurring (for example, that the driver is driving to work early, and so on). For example, the drive mode learning algorithm may make such suggestions based on driving patterns and/or vehicle drives over a period of time. In certain exemplary embodiments, the drive mode learning algorithm would essentially pre-populate a form in the programming interface 104 and/or the vehicle interface 102 for further inputs from and/or completion and/or confirmation from the driver.

In addition, in a preferred embodiment, the vehicle interface 102 receives information from the server 106 as to appropriate content based upon the driving mode and the occupant's pre-programmed preference, and displays a list of such appropriate content for the occupant for selection by the occupant of content from the list. For example, the list may include one set of appropriate content based on driver preferences if the driver is driving to work on time (for example, financial-related content), another set of appropriate content based on driver preferences if the driver is driving to work late (for example, traffic-related content), another set of appropriate content based on driver preferences if the driver is driving home from work early (e.g., music-related content), another set of appropriate content based on driver preferences if the driver is driving home from work early (e.g., sports-related content), another set of appropriate content based on driver preferences if the driver is driving mid-day during the weekdays (e.g., talk show-related content), another set of appropriate content based on driver preferences if the driver is driving on the weekend (e.g., educational-related content), another set of appropriate content based on driver preferences if the driver is driving mid-day during the weekdays (e.g., talk show-related content), and another set of appropriate content based on driver preferences if the driver is driving to a vacation destination (e.g., weather-related content), among various other different possible types of content for these and/or various other different types of driving modes for the vehicle drive, all preferably based on the driver's pre-programmed preferences for such driving modes.

In addition, in a preferred embodiment, the vehicle interface 102 receives one or more inputs from the driver regarding the occupant's selection from the content list, and provides (either directly and/or via one or more media devices coupled thereto), the selected content for the occupant during the vehicle drive. In one preferred embodiment, the vehicle interface 102 also includes a display option for the occupant to request that the vehicle interface 102 “Play All” of the content items from the list.

In one preferred embodiment, the vehicle interface 102 includes a touch screen, such as a liquid crystal display (LCD) touch screen for use by the driver of the vehicle. However, this may vary in other embodiments. The vehicle interface 102 may include any one or more of a number of other types of structural and/or functional components in various embodiments of the present invention.

In addition, in one preferred embodiment, the vehicle interface 102 is coupled to one or more non-depicted media devices having various media files stored therein. For example, in one exemplary embodiment, the vehicle interface 102 is coupled to one or more storage drives, radios, mp3 players, compact disk players, and/or other media devices with media files of information or entertainment selections (for example, podcasts, media files, audio information, audio entertainment, financial content, sports content, news content, weather content, travel content, traffic content, music content, educational content, political content, talk show content, and/or audiobooks, among various other types of content).

The programming interface 104 is configured to obtain from the driver or other occupant of the vehicle information as to such occupant's preferences for different types of content to be played for different types of driving modes that may be experienced during various vehicle drives over time. For example, in one preferred embodiment, the programming interface 104 obtains information as to the driver's content preferences for driving to work, the driver's preferences content for driving home from work, the driver's content preferences for driving on the weekend, the driver's content preferences for driving to one or more vacation destinations, and so on, for various different types of driving modes that the driver is likely to experience while driving the vehicle. For example, in one such embodiment, a particular driver may prefer to listen to financial-related content during the morning drive to work, traffic-related content during the evening drive home from work, sports-related content during the weekend drives, weather related content when approaching certain vacation destinations, and different types of music and/or other different types of content for various other driving modes, among any number of different possible preferences for any number of different types of driving modes for any number of different drivers or other occupants of the vehicle.

In addition, in one preferred embodiment, the programming interface 104 comprises a web-based interface that is accessible by the driver and/or other occupants of the vehicle from the driver and/or other occupant's computer. Accordingly, the driver and/or other occupant of the vehicle can provide his or her inputs ahead of time through the programming interface 104, for example via a personal computer that interfaces with the programming interface 104 via the Internet and/or another network or connection, so that the driver or other occupant of the vehicle can enjoy his or her preferred content for various driving modes as such driving modes arise during vehicle drives. However, the programming interface 104 may vary in other embodiments.

In the depicted embodiment, the server 106 is coupled to the vehicle interface 102 and the programming interface 104. In an exemplary embodiment, the server 106 is configured to determine a driving mode of the vehicle based on one or more characteristics of the vehicle drive using the information provided by the vehicle interface 102, and determining appropriate content for the occupant based on the driving mode using the driver/occupant preference inputs provided by the programming interface 104. In a preferred embodiment, the server determines the driving mode based on one or more of the following: a day of the week, a time of day, a geographic location, and/or a geographic direction of travel of the vehicle during the vehicle drive. In certain embodiments, the determination of the driving mode is made by both the server 106 and the vehicle interface 102 working in tandem with one another.

Also in a preferred embodiment, the server 106 is coupled to the programming interface 104 via the back-end connection 108 and to the vehicle interface 102 via the vehicle connection 110. In one preferred embodiment, the back-end connection 108 comprises an Internet connection, another type of network connection, a cellular connection, and/or another type of wireless connection (e.g., WiFi or WiMax, among others). However, this may vary in other embodiments. Also in a preferred embodiment, the vehicle connection 110 also comprises an Internet connection, another type of network connection, a cellular connection, and/or another type of wireless connection (e.g., WiFi or WiMax, among others). However, this may also vary in other embodiments.

In the depicted embodiment, the server 106 comprises a computer system 112. As depicted in FIG. 1, the computer system 112 includes a processor 114, a memory 116, a computer bus 120, and a storage device 118, as will now be described in greater detail in accordance with one exemplary embodiment of the present invention.

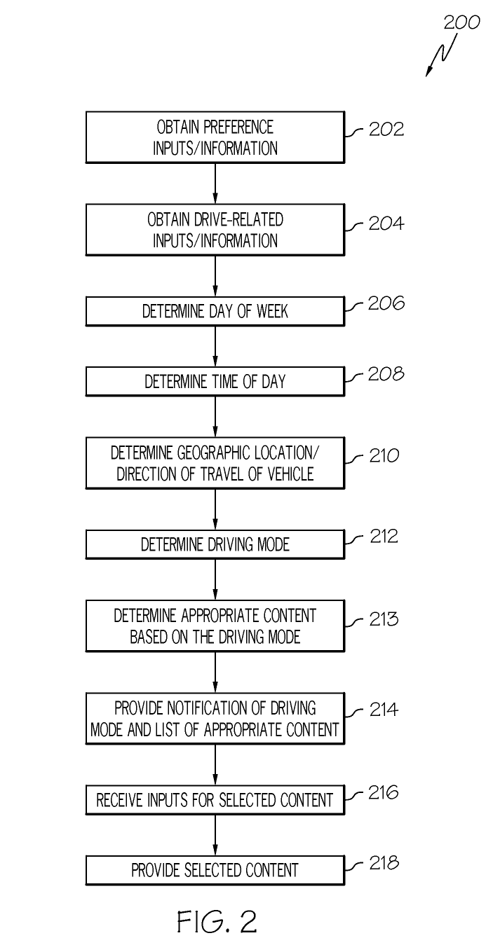

The processor 114 performs the computation and control functions of the computer system 112 or portions thereof, and may comprise any type of processor or multiple processors, single integrated circuits such as a microprocessor, or any suitable number of integrated circuit devices and/or circuit boards working in cooperation to accomplish the functions of a processing unit. During operation, the processor 114 executes one or more programs 124 preferably stored within the memory 116 and, as such, controls the general operation of the computer system 112. In so doing, the processor 114 preferably executes one or more programs 124 stored in the memory 116 in conducting the steps of the process 200 depicted in FIG. 2 and described further below in connection therewith.

As referenced above, the memory 116 stores a program or programs 124 that execute one or more embodiments of processes such as the process 200 described below in connection with FIG. 2 and/or various steps thereof and/or other processes, such as those described elsewhere herein. The memory 116 can be any type of suitable memory. This would include the various types of dynamic random access memory (DRAM) such as SDRAM, the various types of static RAM (SRAM), and the various types of non-volatile memory (PROM, EPROM, and flash). It should be understood that the memory 116 may be a single type of memory component, or it may be composed of many different types of memory components. In addition, the memory 116 and the processor 114 may be distributed across several different computers that collectively comprise the computer system 112. For example, a portion of the memory 116 may reside on a computer within a particular apparatus or process, and another portion may reside on a remote computer.

The computer bus 120 serves to transmit programs, data, status and other information or signals between the various components of the computer system 112. The computer bus 120 can be any suitable physical or logical means of connecting computer systems and components. This includes, but is not limited to, direct hard-wired connections, fiber optics, infrared and wireless bus technologies.

The storage device 118 can be any suitable type of storage apparatus, including direct access storage devices such as hard disk drives, flash systems, floppy disk drives and optical disk drives. In one exemplary embodiment, the storage device 118 is a program product from which memory 116 can receive a program 124 that executes one or more embodiments of the process 200 of FIG. 2 and/or steps thereof as described in greater detail further below. In one preferred embodiment, such a program product can be implemented as part of, inserted into, or otherwise coupled to the computer system 112 and/or the system 100. As shown in FIG. 1, the storage device 118 can comprise a disk drive device that uses disks 134 to store data. As one exemplary implementation, the computer system 112 may also utilize an Internet website, for example for providing or maintaining data or performing operations thereon.

It will be appreciated that while this exemplary embodiment is described in the context of a fully functioning computer system, those skilled in the art will recognize that the mechanisms of the present invention are capable of being distributed as a program product in a variety of forms, and that the present invention applies equally regardless of the particular type of computer-readable signal bearing media used to carry out the distribution. Examples of signal bearing media include: recordable media such as floppy disks, hard drives, memory cards and optical disks (e.g., disk 134), and transmission media such as digital and analog communication links. It will similarly be appreciated that the computer system 112 may also otherwise differ from the embodiment depicted in FIG. 1, for example in that the computer system 112 may be coupled to or may otherwise utilize one or more remote computer systems and/or other control systems.

FIG. 2 is a flowchart of a process 200 for customizing content for an occupant of a vehicle during a vehicle drive, in accordance with an exemplary embodiment of the present invention. In a preferred embodiment, the process 200 can be implemented in connection with the system 100 of FIG. 1 and/or through program products that can be utilized in connection therewith. However, it will be appreciated that in various embodiments the process 200 may also be utilized in connection with any number of different types of systems and/or other devices.

As depicted in FIG. 2, the process 200 includes the step of obtaining preference related information and inputs as to preferences of the driver or other occupant of the vehicle (step 202). In a preferred embodiment, the information includes information provided by the driver of the vehicle as to the driver's preferences for content (for example, any one or more of a number of different types of information and/or entertainment content preferences, among various other types of possible content) for various possible driving modes that the driver may encounter during one or more upcoming vehicle drives in the future. Also in a preferred embodiment, this information is obtained from the driver by the programming interface 104 of FIG. 1 and then provided to the server 106 of FIG. 1 via the back-end connection 108 of FIG. 1.

In addition, drive-related inputs and information are also obtained (step 204). In a preferred embodiment, the drive-related inputs and information include: a time of day, a day of the week, a month of the year, a day of the month, measures of geographic position, location, or movement of the vehicle, among various other types of inputs and information pertaining to the vehicle drive. In addition, in certain embodiments, the drive-related inputs include information as to the identity of the driver of the vehicle, and the driver's preferences for content are then matched up with the particular driver of the vehicle. Also in a preferred embodiment, the drive-related inputs and information are obtained by the vehicle interface 102 (for example, from one or more sensors, clocks, global positioning service (GPS) devices and/or other devices on the vehicle and/or coupled thereto), and are provided to the server 106 of FIG. 1 via the vehicle connection 110 for processing by the server 106 for processing.

In a preferred embodiment, a day of the week (step 206), a time of day (step 208), and a geographic location and direction of travel (step 210) are each determined. Also in one preferred embodiment, each of these values are determined by the server 106 of FIG. 1 based on the drive-related inputs and information provided by the vehicle interface 102 of FIG. in step 204 and the drive-related characteristics pertaining thereto. However, this may vary in other embodiments. For example, in certain embodiments, the day of the week, the time of day, and/or other values may be determined by the server 106 of FIG. 1 internally and/or via information provided by one or more other sources.

The driving mode is then determined for the vehicle drive (step 212). In a preferred embodiment, the driving mode is determined using the day of the week, the time of day, and the geographic location and direction for the current vehicle drive as determined in steps 206-210 above. However, this may vary in other embodiments. For example, in certain embodiments, the driving mode may be determined by only a subset of these values, and one or more of steps 206-210 may not be necessary. In addition, in certain embodiments, the driving mode may be determined using one or more other different types of values.

Also in one preferred embodiment, the driving mode is determined by the server 106 of FIG. 1. In another preferred embodiment, the driving mode is determined by the server 106 and the vehicle interface 102 of FIG. 1 working in tandem with one another. In yet other embodiments, this and other determinations of the process 200 may be made in whole or in part among one or more different components of the system 100 of FIG. 1 and/or by one or more other systems and/or components. For example, in certain embodiments, such determinations may take place within the vehicle itself. In addition, in certain embodiments, one driving mode may transition into another driving mode, for example based on time. For example, the driving mode may start as an early drive home from work, but then could subsequently turn into a late drive home from work if there is traffic congestion, and so on.

As mentioned above, exemplary driving modes may include the following driving modes, among others: driving to work, driving to work on time, driving to work early, driving to work late, driving home from work, driving home from work early, driving home from work late, weekend driving, vacation driving, morning driving, midday driving, evening driving, city driving, country driving, freeway driving, driving to a specific destination (for example, a skiing destination or a beach destination), and/or any one or more of a number of different possible types of driving modes.

In certain embodiments, various rule precedents are also utilized in situations in which two are more rules would seem to apply. For example, if it is determined that the driver is driving the vehicle during a weekend but is also driving toward his or her place of work, then the driving to work factor may take precedence over the driving during the weekend factor in one exemplary embodiment of the present invention. However, this may vary in other embodiments.

Appropriate content is then determined, based on the driving mode (step 213). In a preferred embodiment, the appropriate content reflects content that is compatible with the preferences of the driver or other occupant of the vehicle for the particular driving mode now being experienced during the vehicle drive. For example, if the driving mode is a morning drive to work, the appropriate content represents content that the driver or other occupant of the vehicle prefers when driving to work in the morning, and so on. In a preferred embodiment, the appropriate content is determined in step 213 based on the preference inputs and information obtained in step 202 that pertain to the driving mode determined in step 212.

In addition, in one preferred embodiment, the appropriate content is also downloaded in step 213. This allows for all of the appropriate content to be downloaded at the same time, which can reduce air time that could otherwise be consumed by downloading the different content items separately at different points in time. However, this may vary in other embodiments, for example in which only the content selected by the driver may be downloaded as part of step 218.

As mentioned above, such preferred or appropriate content may include one or more of the following, among various other types of content: podcasts; financial updates, broadcasts, or related information or content; sports updates, broadcasts, or related information or content; news updates, broadcasts, or related information or content; weather updates, broadcasts, or related information or content; travel updates, broadcasts, or related information or content; traffic updates, broadcasts, or related information or content; political updates, broadcasts, or related information or content; talk shows or related information or content; educational broadcasts, or related information or content; audiobooks or related information or content; music and/or related information or content, and/or specific types of music, genres of music and/or musicians and/or related information or content; specific media personalities or related information or content; and/or other information and/or entertainment selections, among other possible types of content.

A notification is then provided as to driving mode and the appropriate content (step 214). In a preferred embodiment, the notification includes an identification of the particular driving morning (for example, morning drive to work, among various other potential driving modes). Also in a preferred embodiment, the notification includes a display of a list of the appropriate content of step 213 for the current driving mode for the occupant for selection by the driver or other occupant of content from the list. In addition, in a preferred embodiment, the notification is provided by the vehicle interface 102 of FIG. 1 (for example, a touch screen display, among various other possible implementations). Also in one preferred embodiment, a display option is provided via the vehicle interface 102 for the driver or other occupant to request that the vehicle interface 102 “Play All” of the content items from the list.

For example, as discussed above, the list may include one set of appropriate content based on driver preferences if the driver is driving to work on time (for example, financial-related content), another set of appropriate content based on driver preferences if the driver is driving to work late (for example, traffic-related content), another set of appropriate content based on driver preferences if the driver is driving home from work early (e.g., music-related content), another set of appropriate content based on driver preferences if the driver is driving home from work early (e.g., sports-related content), another set of appropriate content based on driver preferences if the driver is driving mid-day during the weekdays (e.g., talk show-related content), another set of appropriate content based on driver preferences if the driver is driving on the weekend (e.g., educational-related content), another set of appropriate content based on driver preferences if the driver is driving mid-day during the weekdays (e.g., talk show-related content), and another set of appropriate content based on driver preferences if the driver is driving to a vacation destination (e.g., weather-related content), among various other different possible types of content for these and/or various other different types of driving modes for the vehicle drive, all preferably based on the driver's pre-programmed preferences for such driving modes.

Inputs are then received for the selected content (step 216). In a preferred embodiment, the inputs include the driver or other occupant's preferences of one or more of the appropriate content from the list that the driver or other occupant wishes to have played or executed during the current vehicle drive. For example, in one preferred embodiment, these inputs may include the driver of the vehicle selected a “Play All” feature of the listed appropriate content determined in step 213 and displayed in step 214. Also in a preferred embodiment, certain drivers may select a subset of the listed appropriate content determined in step 213 and displayed in step 214. In addition, in one preferred embodiment, these inputs as to preferred appropriate content are obtained from the driver or other occupant of the vehicle via the vehicle interface 102 of FIG. 1.

The content selected by the driver or other occupant of the vehicle in step 216 is then provided for the driver or other occupant of the vehicle during the current vehicle drive (step 218). In one preferred embodiment, the content is provided via the vehicle interface 102 of FIG. 1 during the vehicle drive. In another preferred embodiment, the content is provided during the vehicle drive via one or more non-depicted media devices that are coupled to the vehicle interface 102 of FIG. 1 and that have various media files stored therein. Such media devices may include, by way of example only, one or more different types of storage drives, radios, mp3 players, compact disk players, and/or other media devices with media files of information or entertainment selections (for example, podcasts, media files, audio information, audio entertainment, financial content, sports content, news content, weather content, travel content, traffic content, music content, educational content, political content, talk show content, and/or audiobooks, among various other types of content).

In addition, in one preferred embodiment, the selected content is downloaded as part of step 218. However, this may vary in other embodiments. For example, as discussed above, in certain embodiments, the content may have already been downloaded during step 213. The content may also be downloaded separately or together during one or more other steps or as a separate step.

Accordingly, improved methods, program products, and systems are provided for customizing content for drivers and/or other occupants of vehicles. The improved methods, program products, and systems allow the driver or other occupant of the vehicle to pre-program his or her content preferences for various potential driving modes that may arise during future vehicle drives. The improved methods, program products, and systems also allow the driver or other occupant of the vehicle to easily select from the driver or other occupant's preferred types of content as these driving modes arise. This allows for a more pleasure experience for the driver and/or for other occupants of the vehicle during the vehicle drive.

It will be appreciated that the methods, program products, devices, and systems and/or steps and/or components thereof may vary from those presented in the Figures and described herein. In addition, while the methods, program products, and systems were at times described above in connection with vehicles, such as automobiles, it will be appreciated that the methods, program products, and systems may be utilized in any number of different applications.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A method for customizing content for an occupant of a vehicle during a vehicle drive, the method comprising the steps of:
determining a driving mode of the vehicle, the driving mode representing one or more characteristics of the vehicle drive; and
determining appropriate content for the occupant based on the driving mode.

2. The method of claim 1, further comprising the step of:
obtaining an input as to a preference of the occupant for the driving modes;
wherein the step of determining appropriate content for the occupant comprises the step of:
determining appropriate content for the occupant based on the driving mode and the input.

3. The method of claim 1, further comprising the step of:
determining a day of the week for the vehicle drive;
wherein the step of determining the driving mode comprises the step of:
determining the driving mode based on the day of the week.

4. The method of claim 1, further comprising the step of:
determining a time of day for the vehicle drive;
wherein the step of determining the driving mode comprises the step of:
determining the driving mode based on the time of day.

5. The method of claim 1, further comprising the step of:
determining a geographic location, a geographic direction, or both, for the vehicle drive;
wherein the step of determining the driving mode comprises the step of:
determining the driving mode based on the geographic location, the geographic direction, or both.

6. The method of claim 1, further comprising the steps of:
displaying a list of the appropriate content for an occupant of the vehicle;
receiving a selection from the occupant, the selection comprising one or more selected items of the appropriate content from the list; and
providing the selected items for the occupant.

7. The method of claim 6, wherein the selected items are selected from the group consisting of: media files, audio information, and audio entertainment.

8. A program product for customizing content for an occupant of a vehicle during a vehicle drive, the program product comprising:
a program configured to at least facilitate:
determining a driving mode of the vehicle, the driving mode representing one or more characteristics of the vehicle drive; and
determining appropriate content for the occupant based on the driving mode; and
a computer-readable signal-bearing medium bearing the program.

9. The program product of claim 8, wherein the program is further configured to at least facilitate:
obtaining an input as to a preference of the occupant for the driving modes; and
determining appropriate content for the occupant based on the driving mode and the input.

10. The program product of claim 8, wherein the program is further configured to at least facilitate:
determining a day of the week for the vehicle drive; and
determining the driving mode based on the day of the week.

11. The program product of claim 8, wherein the program is further configured to at least facilitate:
determining a time of day for the vehicle drive; and
determining the driving mode based on the time of day.

12. The program product of claim 8, wherein the program is further configured to at least facilitate:
determining a geographic location, a geographic direction, or both, for the vehicle drive; and
determining the driving mode based on the geographic location, the geographic direction, or both.

13. The program product of claim 8, wherein the program is further configured to at least facilitate:
displaying a list of the appropriate content for an occupant of the vehicle;
receiving a selection from the occupant, the selection comprising one or more selected items of the appropriate content from the list; and
providing the selected items for the occupant.

14. The program product of claim 13, wherein the selected items are selected from the group consisting of: media files, audio information, and audio entertainment.

15. A system for customizing content for an occupant of a vehicle during a vehicle drive, the program product comprising:
a vehicle interface configured to at least facilitate providing information pertaining to one or more characteristics of the drive; and
a server configured to at least facilitate:
determining a driving mode of the vehicle based on the one or more characteristics of the vehicle drive; and
determining appropriate content for the occupant based on the driving mode.

16. The system of claim 15, further comprising:
a programming interface configured to at least facilitate obtaining an input as to a preference of the occupant for the driving modes;
wherein the server is further configured to at least facilitate determining appropriate content for the occupant based on the driving mode and the input.

17. The system of claim 15, wherein the server is further configured to at least facilitate:
determining a day of the week for the vehicle drive based on the one or more characteristics of the vehicle drive; and
determining the driving mode based on the day of the week.

18. The system of claim 15, wherein the server is further configured to at least facilitate:
determining a time of day for the vehicle drive; and
determining the driving mode based on the time of day.

19. The system of claim 15, wherein the server is further configured to at least facilitate:
determining a geographic location, a geographic direction, or both, for the vehicle drive; and
determining the driving mode based on the geographic location, the geographic direction, or both.

20. The system of claim 15, wherein the vehicle interface is further configured to at least facilitate:
displaying a list of the appropriate content for an occupant of the vehicle;
receiving a selection from the occupant, the selection comprising one or more selected items of the appropriate content from the list, wherein the selected items are selected from the group consisting of: media files, audio information, and audio entertainment; and
providing the selected items for the occupant.
